(19) United States
(12) Patent Application Publication
(10) Pub. No.: US 2025/0262884 A1
(43) Pub. Date: Aug. 21, 2025

(54) PAINT ROLLER WITH REMOVABLY ATTACHABLE COVER LOCKING MECHANISM

(71) Applicants: Daniel A Sweeney, Apex, NC (US); Scott A Pyle, Braselton, GA (US)

(72) Inventors: Daniel A Sweeney, Apex, NC (US); Scott A Pyle, Braselton, GA (US)

(21) Appl. No.: 18/444,773

(22) Filed: Feb. 19, 2024

(51) Int. Cl. B44D 3/12

(52) U.S. Cl. CPC B44D 3/125

(57) ABSTRACT

A system and associated method of manufacturing includes a roller handle having a connecting rod with first and second ends, a first endcap attached to a first end of the connecting rod, wherein the first endcap is configured to be positioned within at least a first end portion of a roller cover, a second endcap configured to be attached to the second end of the connecting rod and to be positioned within at least a second portion of the roller cover, wherein the first endcap is configured to arrest lateral movement of the roller cover along a first direction parallel to the connecting rod, and a roller cover locking mechanism configured to removably attach to the second endcap to arrest lateral movement of the roller cover along a second direction that is parallel to the connecting rod. The cover locking mechanism may include a threaded endcap that facilitates an easy remove of the roller cover.

### BACKGROUND

The field of the present disclosure relates generally to generally to painting, and more particularly, to paint roller devices.

It is known that the most common paint roller frame assemblies are sized to fit nine inch roller covers which are removably mounted on the roller frame assembly so that the roller cover can be detached from the support after use and cleaned or replaced as desired. Typically, roller covers are frictionally fit and secured to the roller frame assembly. One disadvantage to this type of cover and roller frame assembly is that when put under continual pressure or force by pressing or rolling the cover/frame assembly against a wall or surface, the roller cover will often dislodge from its friction fit on the frame and begin to slide off the frame. This slippage action is often referred to as the roller cover “walking off of the frame.” When such slippage occurs, it creates an unwanted finish on the wall or surface requiring the surface to be re-rolled or re-painted. Placing the same roller cover back on the same frame assembly does not fully resolve the problem as it is still prone to slide off again.

Based on the foregoing, it would be desirable to provide a paint roller frame and cover assembly wherein the roller cover that can be locked into place on the frame preventing roller “walk off” and can be removed quickly and easily with less mess and effort than traditional roller cover removal methods.

### BRIEF DESCRIPTION

In one aspect, an apparatus includes a roller handle having a connecting rod with first and second ends, a first endcap attached to a first end of the connecting rod, wherein the first endcap is configured to be positioned within at least a first end portion of a roller cover, a second endcap configured to be attached to the second end of the connecting rod and to be positioned within at least a second portion of the roller cover, where the first endcap is configured to arrest lateral movement of the roller cover along a first direction parallel to the connecting rod, and a roller cover locking mechanism configured to removably attach to the second endcap to arrest lateral movement of the roller cover along a second direction that is parallel to the connecting rod.

In another aspect, a method of manufacturing includes a roller handle having a connecting rod with first and second ends, a first endcap attached to a first end of the connecting rod, wherein the first endcap is configured to be positioned within at least a first end portion of a roller cover, a second endcap configured to be attached to the second end of the connecting rod and to be positioned within at least a second portion of the roller cover, wherein the first endcap is configured to arrest lateral movement of the roller cover along a first direction parallel to the connecting rod, and a roller cover locking mechanism configured to removably attach to the second endcap to arrest lateral movement of the roller cover along a second direction that is parallel to the connecting rod.

In another aspect, an apparatus and a method of manufacturing includes a paint roller frame and cover cap assembly wherein the roller cover is uniquely locked onto the frame with a threaded male to female ‘screw on/screw off’ end cap mechanism at the frame's ‘open end’ to arrest lateral movement of the roller cover along the axis of the frame rod and cap assembly.

The above description is provided as an overview of only some implementations disclosed herein. Those and other implementations are described in more detail here. In addition, some implementations include one or more processors of one or more computing devices, where the one or more processors are operable to execute instructions stored in associated memory, and where the instructions are configured to cause performance of any of the methods described herein. Some implementations also include one or more non-transitory computer readable storage media storing computer instructions executable by one or more processors to perform any of the methods described herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of an embodiment of a paint roller frame assembly system without an attached roller cover.

FIG. 2 is perspective view of an embodiment of a paint roller frame assembly with an attached roller cover.

FIG. 3 is a perspective view of an embodiment of the paint roller system with a detached screw cap locking mechanism.

FIG. 4 is an exploded perspective view of a roller cover locking mechanism embodiment that includes a male threaded screw design.

FIG. 5 is an exploded perspective view of a roller cover locking mechanism piece that includes a grip texture, as well as a larger diameter that additionally creates a locking barrier to prevent the roller cover walking off of the frame.

FIG. 6 is a perspective view of a locking mechanism comprising a threaded endcap according to an embodiment of the system.

FIG. 7 is a perspective view comparison of the inner diameter of a common roller cover versus the intentionally undersized diameters of the first and second cap pieces.

Although the invention is described with reference to these specific preferred embodiments, it will be understood that the invention is not limited to these preferred embodiments. But to the contrary, the invention includes numerous alternatives, modifications and equivalents and it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

### DETAILED DESCRIPTION

An embodiment of the system includes a paint roller frame assembly that improves the functionality of use and that prevents roller covers from slipping off the frame, makes roller cover removal quick and easy. According to an implementation, a paint roller frame and cover assembly may include a threaded male to female mechanism to lock the roller cover to the frame apparatus. More particularly, the system includes a male to female “screw on/screw off” end locking cap mechanism at the frame's open end to arrest lateral movement of the roller cover along the axis of the frame rod and cap assembly.

The paint roller frame and cap assembly may include a male screw cap having a diameter that is slightly larger than an inner diameter of the companion female roller cap. According to a specific embodiment, the screw/locking cap may be threaded as a male connection and the endcap may have a correspondingly threaded female connection for attachment. However, another implementation may reverse the male and female threading on the screw cap and endcap. The male screw cap may additionally be slightly larger in diameter than the roller cover sleeve. As such, the screw cap may fully be threaded into the female endcap. The screw cap assembly may thus act as a backstop or stopper disc to securely lock the cover onto the roller frame.

An embodiment of the system allows for the easy removal of the roller cover when unlocked. More particularly, the system includes roller frame end caps which are intentionally sized to be smaller than the common inner diameter of most roller covers, thus creating a non-friction fit of the roller caps to the roller cover core.

According to an implementation, the roller cover may rotate and float freely around the frame's end caps when secured by the screw cap locking system. When the screw cap is removed, the undersized cap dimensions described herein allow the roller cover sleeve to easily fall off the frame when tilted in a downward angle.

The outer rim of the threaded locking mechanism may be textured and shaped to create easy gripping and screw-on/screw-off motion by use of fingers only without the need for tools. Another or the same embodiment may include a slot in the outer face of the screw cap to allow a user to insert a flat screwdriver or knife edge in order to turn to unlock or lock the mechanism without having to use the outer rim.

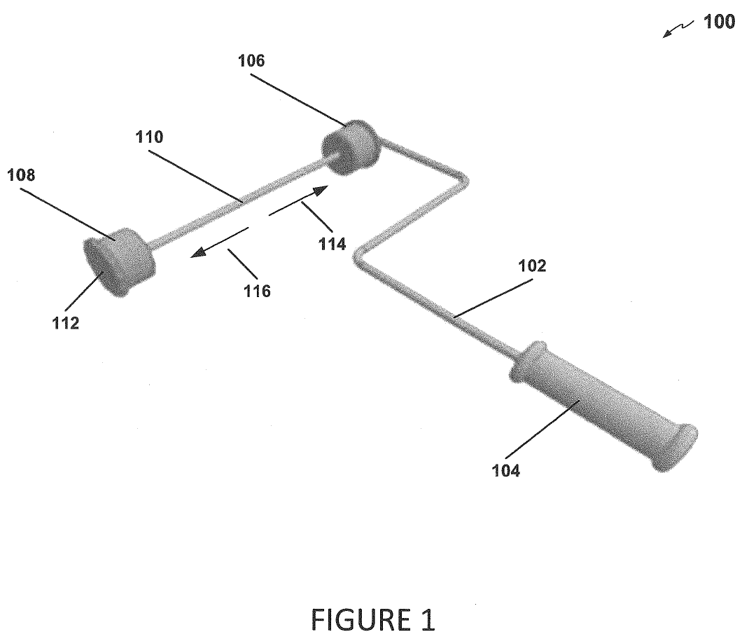

Turning more particularly to the drawings, FIG. 1 is a perspective view of an embodiment of a paint roller frame assembly system 100 without an attached roller cover. The assembly, or apparatus, includes a roller handle 102 with a grip 104, as well as a first end piece 106 attached to the roller handle 102. The first end piece 106 is configured to be positioned within at least a first end portion of a roller cover (not shown).

A second end piece 108, or endcap, may be configured to be positioned within at least a second portion of the roller cover. A connecting rod 110 may be attached to the first and second end pieces 106, 108. The first end piece 106 is configured to arrest lateral movement of the roller cover along a first direction parallel 114 to the connecting rod 110. A roller cover locking mechanism 112 configured to removably attach to the second end piece 108 to arrest lateral movement of the roller cover along a second direction 116 that is parallel to the connecting rod 110.

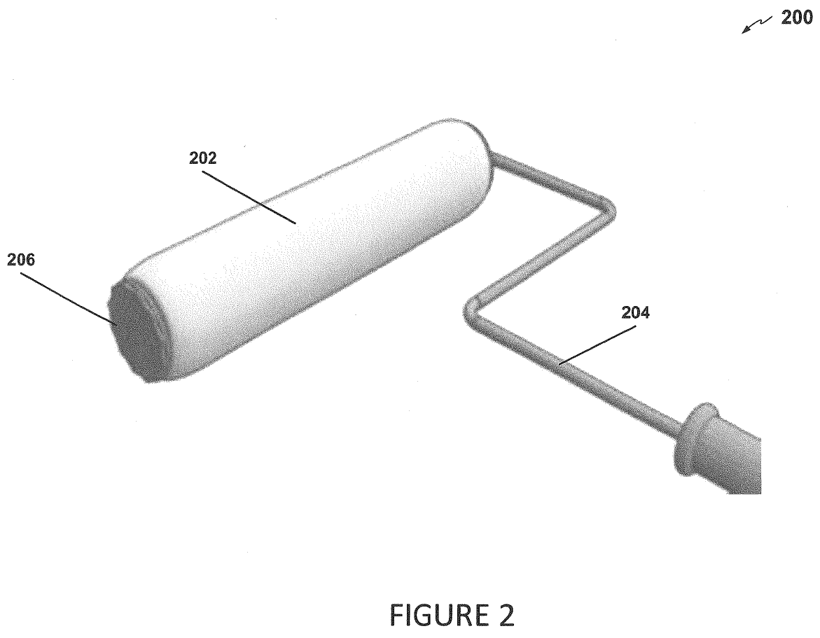

FIG. 2 is perspective view of an embodiment of a paint roller frame assembly 200 with an attached roller cover 202 secured by a locking mechanism 206. The assembly also shows a handle 204 in addition to the locking mechanism 206, or screw cap.

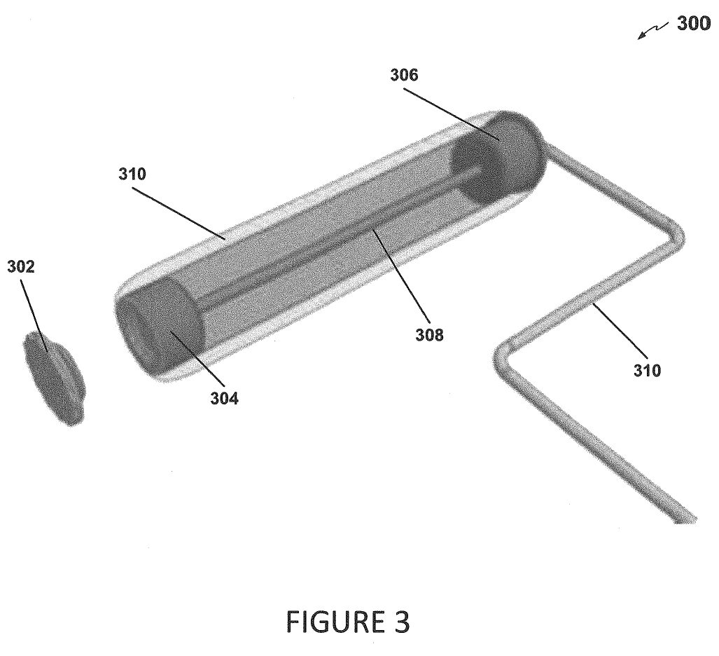

FIG. 3 is a perspective view of an embodiment of the paint roller system 300 with a detached screw cap locking mechanism 302. The system 300 also includes end pieces 304, 306 connected by a rod 308 (as visible through the cross-section of the roller cover 310.

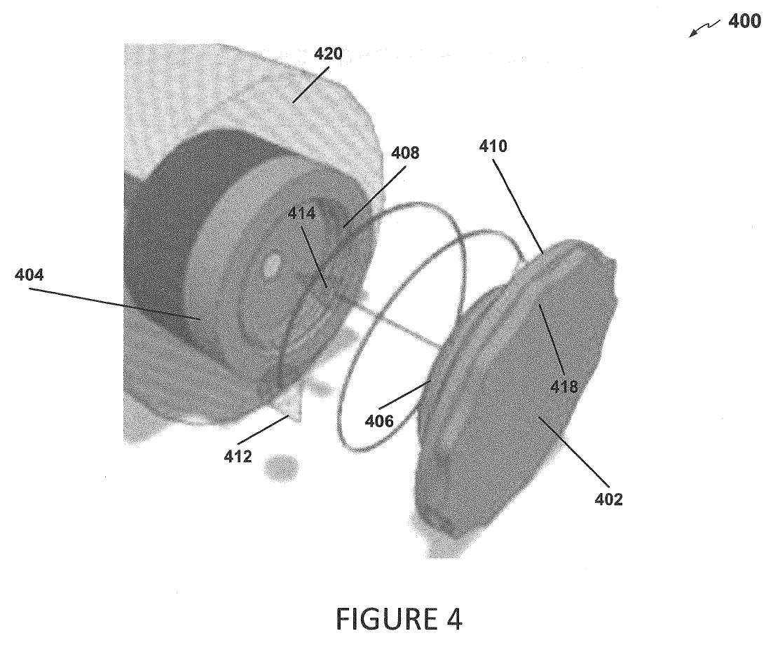

FIG. 4 is an exploded perspective view of a roller cover locking mechanism system 400 that includes a male threaded screw design. As illustrated, the system 400 a locking mechanism screw cap 402 that screws into an endcap 404 in the directions indicated by the arrows 412, 414. To this end, the screw cap 402 includes threads 406 that correspond to mating threads 408 recessed in the endcap 404. As described herein, the screw cap 402 includes a contoured edge 418 that may be ergonomically shaped for gripping. The edge 418 may further be grooved or otherwise textured (not shown). An arresting surface 410 of the screw cap 402 may be sized to have a larger diameter than the endcap 404 to prevent the roller cover 420 from slipping off when secured.

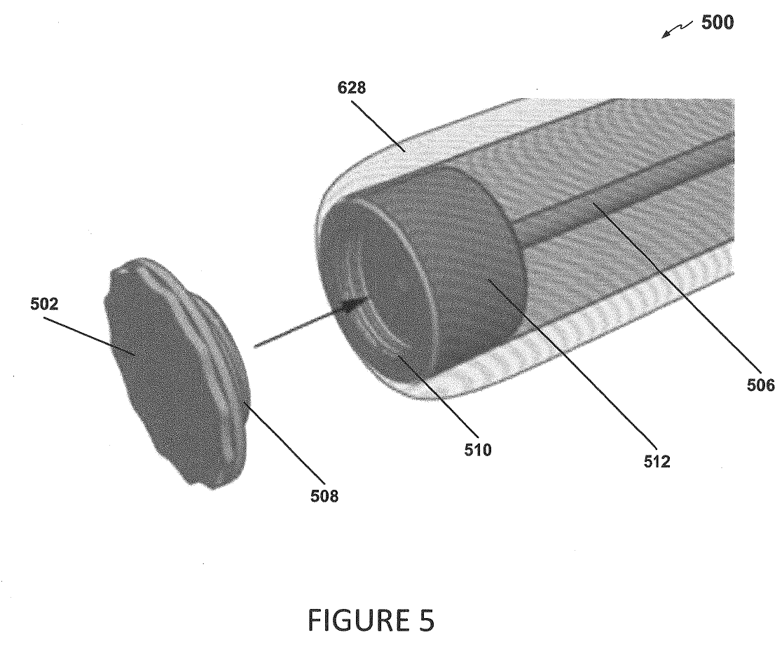

FIG. 5 is an exploded perspective view of a roller cover locking mechanism 502, or threaded cap, which is manufactured to include a grip texture and a relatively larger diameter that creates a locking barrier to prevent a roller cover 504 from walking off of a connecting rod 628 of a frame. The locking mechanism 502 may also include threads 508 that mate with threads 510 of an endcap 512.

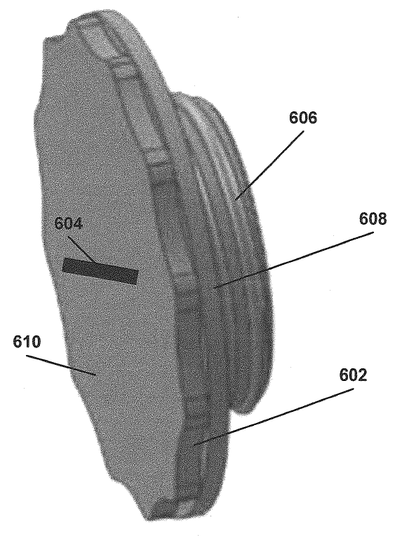

FIG. 6 is a perspective view of a locking mechanism 600 comprising a threaded endcap according to an embodiment of the system. The outer rim 602 of the threaded locking mechanism 600 may be textured and shaped to create easy gripping and screw-on/screw-off motion by use of fingers only without the need for tools. Other shapes are contemplated (rectangular, triangular, webbed, etc.). The illustrated embodiment includes a slot 604 in the outer face 610 of the screw cap to allow the user to insert a flat screwdriver or knife edge and turn to turn the threads 606 to unlock or lock the mechanism without having to use the outer rim. A barrier portion 608 positioned on the roller cover side may prevent slippage of the roller cover while the locking mechanism is engaged.

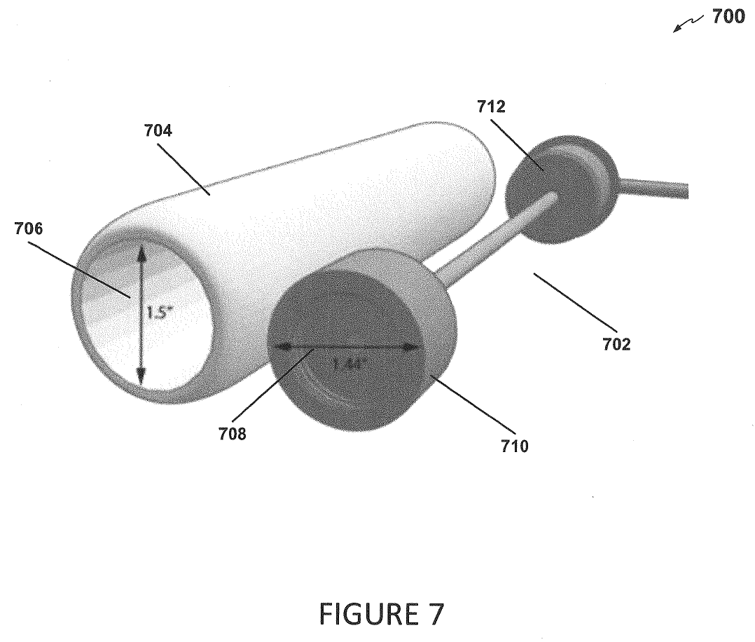

FIG. 7 is a perspective view of a system 700 that includes a roller frame assembly 702 next to a roller cover 704 to illustrate a difference in respective sizes of the inner diameter 706 of a common roller 710 cover versus the intentionally undersized diameter 708 of the first and second cap pieces 710, 712. According to an implementation, the roller cover may rotate and float freely around the endcaps 710, 712. When the screw cap (not shown) is removed, the dimensions described herein allow the roller cover 704 to easily fall off the frame 702 when tilted in a downward angle.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An apparatus comprising:
a roller handle having a connecting rod with first and second ends;
a first endcap attached to a first end of the connecting rod, wherein the first endcap is configured to be positioned within at least a first end portion of a roller cover;
a second endcap configured to be attached to the second end of the connecting rod and to be positioned within at least a second portion of the roller cover, wherein the first endcap is configured to arrest lateral movement of the roller cover along a first direction parallel to the connecting rod; and
a roller cover locking mechanism configured to removably attach to the second endcap to arrest lateral movement of the roller cover along a second direction that is parallel to the connecting rod.

2. The apparatus of claim 1, wherein the roller cover locking mechanism includes a twist-lock threaded screw cap.

3. The apparatus of claim 1, wherein the first and second endcaps are undersized relative to the inner diameter of a roller cover to facilitate easy removal when the roller cover locking mechanism is released.

4. The apparatus of claim 1, wherein the roller cover locking mechanism includes a surface having a diameter that is larger than the second endcap.

5. The apparatus of claim 1, wherein the roller cover locking mechanism includes a surface having textured surface for gripping.

6. The apparatus of claim 1, wherein the roller cover locking mechanism includes a contoured shape for gripping.

7. A method of manufacturing a roller cover assembly, the method comprising:
attaching a first endcap to a connecting rod of a roller handle, wherein the first endcap is configured to be positioned within at least a first end portion of a roller cover;
attaching a second endcap to the connecting rod, wherein the second endcap is configured to be positioned within at least a second end portion of the roller cover, wherein the first endcap is configured to arrest lateral movement of the roller cover along a first direction parallel to the connecting rod; and
providing a roller cover locking mechanism configured to removably attach to the second endcap to arrest lateral movement of the roller cover along a second direction that is parallel to the connecting rod.
